(19) United States
(12) Patent Application Publication
(10) Pub. No.: US 2024/0318624 A1
(43) Pub. Date: Sep. 26, 2024

(54) WIND TURBINE POWER GENERATION DEVICE

(71) Applicant: GREEN POWER BY ACCELERATED FLOW RESEARCH LIMITED LIABILITY COMPANY, Kanagawa (JP)

(72) Inventors: Souichirou ASAI, Kanagawa (JP); Kunimitsu SATO, Kanagawa (JP); Norio SEITOKU, Saitama (JP); Yasutaka YOSHIBA, Chiba (JP)

(21) Appl. No.: 18/577,673

(22) PCT Filed: Mar. 28, 2022
(86) PCT No.: PCT/JP2022/014999

§ 371 Date: Jan. 8, 2024

(30) Foreign Application Priority Data
Dec. 23, 2021 (JP) 2021-209432

(51) Int. Cl. F03D 1/04; F03D 9/25; H02K 7/18

(52) U.S. Cl. CPC F03D 1/04; F03D 9/25; H02K 7/183; F05B 2250/501

(57) ABSTRACT

The wind turbine generator includes a rotating disk and a wind turbine generator including a wind turbine, a generator, and a wind collection body, and supports the wind turbine generator at a point away from a center of the rotating disk with a wind flow inlet of the wind collection body facing the center of the rotating disk.

### CROSS-REFERENCE TO RELATED APPLICATIONS

This application is national stage application of International Application No. PCT/JP2022/014999, filed on Mar. 28, 2022, which claims the benefit of priority from Japanese Patent Application No. 2021-209432, filed on Dec. 23, 2021.

### TECHNICAL FIELD

The present invention relates to a wind turbine power generation device in which a wind turbine generator exerts a yaw function to face a wind direction, a rotation efficiency of the wind turbine and the generator is improved to increase generated power, and installation stability, a problem of height, and the like are improved.

### BACKGROUND ART

In recent years, there has been a demand for prevention of global warming, and there is an urgent need to develop new clean energy. A wind power generation system that does not emit CO₂ is attracting attention as this clean energy. However, although wind power generation is currently being developed, the position of wind power generation as an alternative energy to oil is currently low. Therefore, it is necessary to develop a means for effectively capturing wind power energy.

The mainstream of current wind power generation systems is a lift-type propeller-type wind turbine. In the case of this propeller-type wind turbine, long blades (propeller blades) are required, an energy efficiency thereof is about 40%, and about 40% of the wind power energy is currently captured. Incidentally, the theoretical highest efficiency is 59.3% (Betz's law).

The above wind power generation system has been developed in the following direction: (1) the wind power generation system includes a blade having a rotation diameter as large as possible, (2) the wind power generation system is installed at a position as high as possible, and (3) the wind power generation system is installed at a place where wind blows as much as possible. However, when a diameter of the blade is increased in order to catch as much wind as possible, it is necessary to increase the height of a pillar. As a result, there is a problem that the pillar becomes unstable against strong wind, and when a rotation of the blade is not stopped at a time of strong wind, the device is damaged. Therefore, there are problems of height and installation stability, and a construction cost is as enormous as several hundred million yen.

Furthermore, in order to improve a rotation efficiency of a wind power generator to improve a power generation efficiency to increase generated power, it is necessary to control the wind power generator to face a wind direction.

Conventionally, a wind condition measuring method and a wind power generation device have been proposed in which a plurality of wind direction data is acquired by an anemometer, and a yaw error corresponding to the plurality of acquired wind direction data is read from a database in which a relationship between the wind direction data and the yaw error is stored in advance (Patent Literature 1). However, all of these devices require an anemometer, a complicated control device, and the like.

In addition, wind collection-type wind turbines applicable to the present invention have been proposed (Patent Literature 2 to 4).

### CITATION LIST

### Patent Literature

Patent Literature 1: JP 2020-193605 A
Patent Literature 2: JP 2011-140887 A
Patent Literature 3: 6033870 B2
Patent Literature 4: 6110455 B2

### SUMMARY OF INVENTION

### Technical Problem

In view of the above circumstances, an object of the present invention is to provide a wind turbine power generation device in which a wind turbine generator exerts a yaw function to face a wind direction, a rotation efficiency of the wind turbine and the generator is improved to increase generated power, and installation stability, a problem of height, and the like are improved.

### Solution to Problem

In order to solve the above problems, a wind turbine power generation device of the present invention includes a rotating disk and a wind turbine generator including the wind turbine, the power generator, and a wind collection body, and supports the wind turbine generator at a point away from a center of the rotating disk with a wind flow inlet of the wind collection body facing the center of the rotating disk (claim 1).

According to the present invention, the wind turbine generator is supported at a point away from the center of the rotating disk. Furthermore, the wind turbine generator is supported with the wind flow inlet of the wind collection body facing the center of the rotating disk.

Therefore, when wind hits the wind turbine generator, the wind turbine generator is automatically moved to a leeward side of the wind from the center of the rotating disk and faces a wind direction in all directions.

That is, a yaw function automatically works with respect to the wind direction, the wind is continuously supplied to the wind turbine generator, a rotation efficiency of the wind turbine and the generator is improved, and generated power is increased. Furthermore, the present invention does not require a complicated device such as an additional anemometer and a control device for data thereof.

An embodiment of the present invention is characterized in that the rotating disk has a central pillar, the wind turbine generator has a support pillar, and the wind turbine generator is supported by the support pillar and the central pillar (claim 2). According to this embodiment, by using the central pillar, it is easy to support the wind flow inlet of the wind collection body toward the center of the rotating disk, and a mounting strength of the wind turbine generator can be increased.

An embodiment of the present invention is characterized in that the wind collection body is formed such that a cross-sectional area of a front wind collection body reduces linearly or curvilinearly between the wind flow inlet and a position where the wind turbine is installed, and the reduced cross-sectional area of the front wind collection body increases linearly or curvilinearly between the position where the wind turbine is installed and a wind flow outlet, or is formed so as to maintain the same cross-sectional area (claim 3).

According to this embodiment, a speed of the wind collected in the wind turbine is increased, the rotation efficiency of the wind turbine and the generator is improved, and generated power is increased.

According to an embodiment of the present invention, the wind collection body has a substantially rectangular cross section including a short side portion and a long side portion, and a ratio of the short side portion to the long side portion of the wind collection body is set to 1 to 10 times and a ratio of a short side portion to a long side portion of an outlet portion of a rear wind collection body is set to 1 to 10 times by minimizing a distance between the wind turbine and the long side portion of the wind collection body (claim 4).

Here, the substantially rectangular cross section includes an elliptical shape having a short side portion and a long side portion and other polygonal shapes. According to this embodiment, as compared with a case where the wind collection body has a circular shape or a square shape, a wind velocity flowing beside the wind turbine is supplied to space portions on both sides of the wind turbine without releasing the wind velocity to upper and lower sides of the wind turbine, and an airflow having a reduced speed on a back surface of the wind turbine is effectively knocked out, so that a speed energy of the airflow on the back surface of the wind turbine can be recovered.

First, when wind is received from the wind flow inlet, the wind passes through the front wind collection body to reach a wind turbine installed in a reducer having a substantially rectangular cross section, and rotates the wind turbine. At the same time, a high-speed airflow from the space portions on both sides of the wind turbine blows out. Then, the high-speed airflow blowing through the space portions on both sides of the wind turbine blows out the airflow having a reduced speed on the back surface of the wind turbine, an energy of which is deprived by the wind turbine, and the speed energy of the airflow on the back surface of the wind turbine is recovered. As a result, the speed of the wind is increased by the front wind collection body formed so that the cross-sectional area reduces linearly or curvilinearly between the wind flow inlet and the position where the wind turbine is installed, the wind is guided to the wind turbine, and an amount and a speed of the wind passing through the wind turbine are increased and supplied to the rear wind collection body.

Next, the wind having passed through the wind turbine is supplied to the rear wind collection body. The rear wind collection body is formed such that the reduced cross-sectional area increases linearly or curvilinearly between the position where the wind turbine is installed and the wind flow outlet or maintains the same cross-sectional area. With respect to the wind supplied to the rear wind collection body having passed through the wind turbine, lower speed, higher pressure wind inside the rear wind collection body blown through the outside of the rear wind collection body in contact with higher speed, lower pressure airflow and supplied by mixing, friction, and absorption is pulled out from the wind flow outlet, and the amount and speed of the wind passing through the wind turbine are increased again. That is, the wind speed on the back surface of the wind turbine is increased by a two-stage wind speed acceleration to improve the rotation efficiency of the wind turbine, thereby increasing a power generation efficiency.

Furthermore, the distance between the wind turbine and the long side portion of the wind collection body is minimized, the ratio of the short side portion and the long side portion of the wind collection body is set to 1 to 10 times, and the ratio of the short side portion and the long side portion of the outlet portion of the rear wind collection body is set to 1 to 10 times. In the ratio of 1 to 10 times, when the ratio exceeds 10 times, an increase in a peripheral length/area ratio with respect to the area does not become large. In addition, if the ratio exceeds 10 times, there is also a problem that a size of the device is increased.

An embodiment of the present invention is characterized in that a wind dispersing portion is provided having a shape in which wind outside the wind collection body is dispersed at a mouth edge of the wind flow outlet of the wind collection body and the wind outside the wind collection body increases a contact area with wind inside the wind collection body (claim 5). According to this embodiment, wind existing at a small flow rate behind the wind turbine can be forcibly expelled, and the rotation efficiency of the wind turbine and the generator can be improved to increase generated power.

### Advantageous Effects of Invention

According to the present invention, it is possible to provide a wind turbine power generation device in which the rotation efficiency of the wind turbine generator is improved by the automatic yaw control to increase generated power, and installation stability, a problem of height, and the like are improved.

### BRIEF DESCRIPTION OF DRAWINGS

FIG. 1 is a plan view of a main part of a wind collection-type wind turbine according to an embodiment of the present invention.

FIG. 2 is a side view of the main part of FIG. 1.

FIG. 3 is a front view of the main part of FIG. 1.

FIG. 4 is a plan view of a main part of a wind collection-type wind turbine according to another embodiment of the present invention.

FIG. 5 is a side view of the main part of FIG. 4.

FIG. 6 is a front view of the main part of FIG. 4.

FIG. 7 is a front view of cutout protrusion wind dispersing portions.

FIGS. 8A, 8B and 8C are front views of star-shaped wind dispersing portions.

FIG. 9 is a front view of a flange-shaped wind dispersing portion.

FIG. 10 is a front view of a gear-shaped wind dispersing portion.

### DESCRIPTION OF EMBODIMENTS

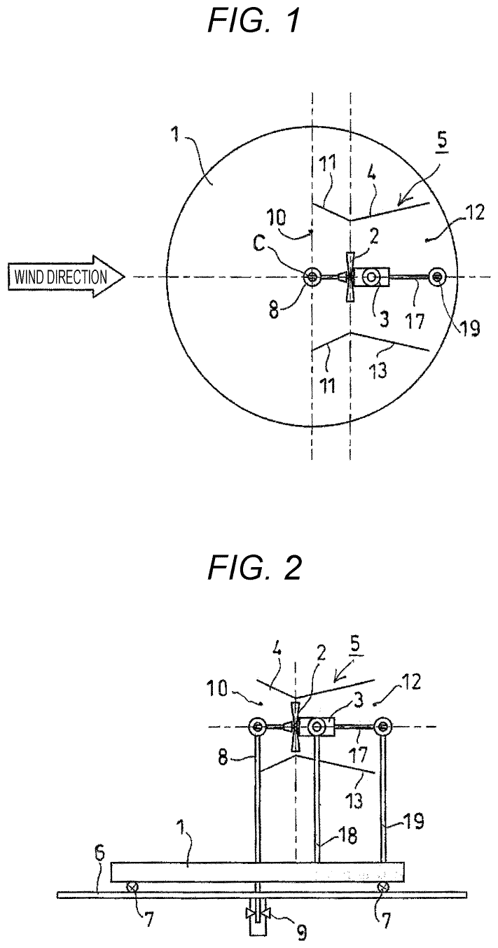

Hereinafter, an embodiment of the present invention will be described with reference to FIGS. 1 to 3.

A wind turbine power generation device of the present invention includes a wind turbine generator 5 including a rotating disk 1, a wind turbine 2, a generator 3, and a wind collection body 4.

The rotating disk 1 is supported via a plurality of rollers 7 arranged on a fixed base 6, and is configured to be rotatable about a center C thereof as an axis. Furthermore, a central pillar 8 is provided at the center C. The central pillar 8 is configured to be rotatable by a bearing 9 provided on the fixed base 6.

The wind turbine generator 5 has a configuration in which the wind turbine 2 and the generator 3 are arranged inside the wind collection body 4. The wind collection body 4 includes a front wind collection body 11 whose cross-sectional area is formed to be reduced linearly or curvilinearly between a wind flow inlet 10 and a position where the wind turbine 2 is installed, and a rear wind collection body 13 whose reduced cross-sectional area is formed to be increased linearly or curvilinearly between the position where the wind turbine 2 is installed and a wind flow outlet 12 or to maintain the same cross-sectional area, and has a substantially rectangular cross section having a short side portion 14 and a long side portion 15.

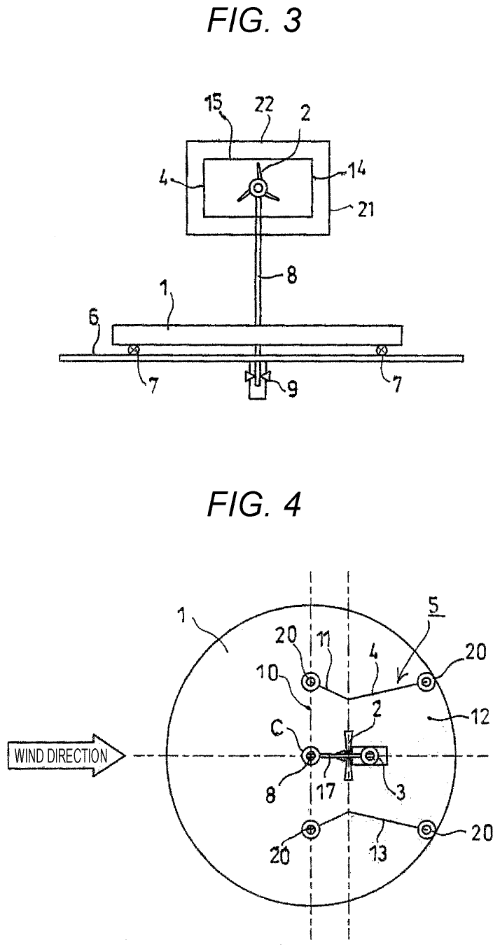

Furthermore, as shown in FIGS. 3 and 6, a distance between the wind turbine 2 and the long side portion 15 of the wind collection body 4 is minimized, a ratio of the short side portion 14 and the long side portion 15 of the wind collection body 4 is set to 1 to 10 times, and a ratio of a short side portion 21 and a long side portion 22 of an outlet portion of the rear wind collection body 13 is set to 1 to 10 times. The wind collection body 4 is used in horizontal long or vertical long according to an installation place of the present wind turbine power generation device.

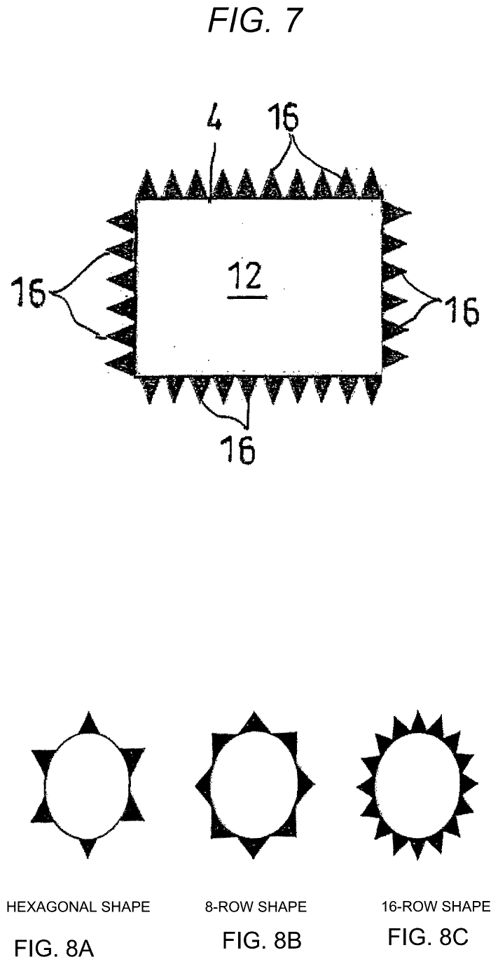

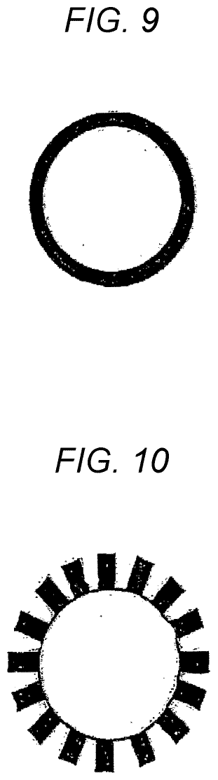

Furthermore, a wind dispersing portion having a shape that disperses wind outside the wind collection body 4 and increases a contact area between the wind outside the wind collection body 4 and wind inside the wind collection body 4 is provided at a mouth edge of the wind flow outlet 12 of the wind collection body 4. FIG. 7 illustrates cutout protrusion dispersing portions 16. The shape of the wind dispersing portion is not limited. For example, a star-shaped dispersing portion illustrated in FIGS. 8A, 8B and 8C, a flange-shaped dispersing portion illustrated in FIG. 9, a gear-type dispersing portion illustrated in FIG. 10, or other shapes may be used.

In the present invention, the wind turbine 2, the generator 3, and the wind collection body 4 constituting the wind turbine generator 5 are supported at a point away from the center C of the rotating disk 1. Furthermore, the wind turbine generator 5 is supported with the wind flow inlet 10 of the wind collection body 4 facing the center C of the rotating disk 1.

In the embodiment of the drawings, the wind turbine generator 5 is supported by a support pillar 18, and both ends of a main shaft 17 of the wind turbine generator 5 are supported on the rotating disk 1 by a main shaft pillar 19 provided separately from the central pillar 8.

In the above configuration, the rotating disk 1 is rotatable. Therefore, when wind hits the wind turbine generator 5, the rotating disk 1 rotates, and at the same time, the wind turbine generator 5 is moved to the leeward side of the wind from the center C of the rotating disk 1, and the wind flow inlet 10 of the wind collection body 4 faces a wind direction in all directions.

Since the wind flow inlet 10 of the wind collection body 4 of the wind turbine generator 2 always faces the wind direction, the wind turbine 10 is always rotated while capturing the wind, a rotation efficiency of the generator 3 is improved, and a power generation efficiency is improved.

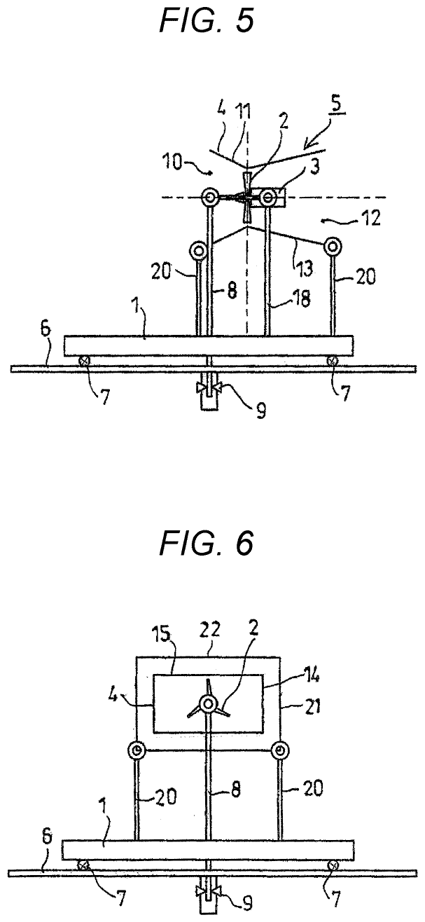

Next, an embodiment of FIGS. 4 to 6 will be described. Note that reference numerals common to those in FIGS. 1 to 3 are denoted by the same reference numerals.

In this embodiment, the wind turbine 2 and the generator 3 are supported by the central pillar 8 and the support pillar 18 of the wind turbine generator 5, and both ends of the wind collection body 4 are supported by support pillars 20, thereby improving a strength against wind power.

### INDUSTRIAL APPLICABILITY

Since the wind turbine power generation device exerts a yaw function to face the wind direction, and the rotation efficiency of the wind turbine and the generator can be improved to increase generated power, the application field thereof is vast.

1. A wind turbine power generation device comprising: a rotating disk; and a wind turbine generator including a wind turbine, a generator, and a wind collection body, wherein the wind turbine generator is supported at a point away from a center of the rotating disk with a wind flow inlet of the wind collection body facing the center of the rotating disk.

2. The wind turbine power generation device according to claim 1, wherein the rotating disk has a central pillar, the wind turbine generator has a support pillar, and the wind turbine generator is supported by the support pillar and the central pillar.

3. The wind collection power generation device according to claim 1, wherein the wind collection body includes: a front wind collection body whose cross-sectional area is formed to be reduced linearly or curvilinearly between the wind flow inlet and a position where the wind turbine is installed; and a rear wind collection body whose reduced cross-sectional area is formed to be increased linearly or curvilinearly between the position where the wind turbine is installed and a wind flow outlet or to maintain the same cross-sectional area.

4. The wind turbine power generation device according to claim 1, wherein the wind collection body has a substantially rectangular cross section having a short side portion and a long side portion, and a ratio of the short side portion to the long side portion of the wind collection body is set to 1 to 10 times and a ratio of a short side portion to a long side portion of an outlet portion of the rear wind collection body is set to 1 to 10 times by minimizing a distance between the wind turbine and the long side portion of the wind collection body.

5. The wind turbine power generation device according to claim 1, wherein a wind dispersing portion having a shape in which wind outside the wind collection body is dispersed at a mouth edge of the wind flow outlet of the wind collection body and the wind outside the wind collection body increases a contact area with wind inside the wind collection body is provided.
